(19) United States
(12) Patent Application Publication
(10) Pub. No.: US 2022/0012648 A1
(43) Pub. Date: Jan. 13, 2022

(54) INFORMATION PROCESSOR, INFORMATION PROCESSING METHOD, AND NON-TEMPORARY STORAGE MEDIUM

(71) Applicant: TOYOTA JIDOSHA KABUSHIKI KAISHA, Toyota-shi (JP)

(72) Inventors: Naoki Uenoyama, Nisshin-shi (JP); Hideo Hasegawa, Nagoya-shi (JP); Yuya Kokubun, Nagoya-shi (JP); Kaede Abe, Nagoya-shi (JP)

(73) Assignee: TOYOTA JIDOSHA KABUSHIKI KAISHA, Toyota-shi (JP)

(21) Appl. No.: 17/369,269

(22) Filed: Jul. 7, 2021

(30) Foreign Application Priority Data
Jul. 8, 2020 (JP) 2020-117583

(51) Int. Cl. G06Q 10/02; G06Q 10/06; B60L 58/13

(52) U.S. Cl. CPC G06Q 10/02; B60L 58/13; G06Q 10/06314

(57) ABSTRACT

The present disclosure provides a technique of efficiently managing the reservation of company vehicles.

An information processor according to the, present disclosure includes a controller configured to acquire information on the usage state and the due date and time of the company vehicle having been lent, calculate a preparation time from the due date and time to a state in which the company vehicle is available, based on the information on the usage state of the company vehicle, and set an available date and time when the company vehicle after being returned is available, based on the due date and time and the preparation time.

### CROSS REFERENCE TO THE RELATED APPLICATION

This application claims the benefit of Japanese Patent Application No. 2020-117583, filed on Jul. 8, 2020, which is hereby incorporated by reference herein in its entirety.

### BACKGROUND

### Technical Field

The present disclosure relates to a technique for managing the reservation of vehicles (company vehicles) to be lent to employees.

### Description of the Related Art

A technique of determining a pattern for connecting a charging cable to each electric vehicle according to the remaining battery power of each electric vehicle is proposed for the use of multiple electric vehicles (EVs) as rental cars (for example, see Japanese Patent Laid-Open No. 2015-195664).

[Patent document 1] Japanese Patent Laid-Open No. 2015-195664

### SUMMARY

One or more aspects of the present disclosure are directed to provide a technique of efficiently managing the reservation of company vehicles.

One aspect of the present disclosure can be regarded as an information processor for managing company vehicles to be lent to employees.

In this case, the information processor may include a controller including at least one processor configured to perform:

acquiring information on the usage state and the due date and time of the company vehicle having been lent;

calculating a preparation time from the due date and time to a state in which the company vehicle is available, based on the information on the usage state of the company vehicle; and

setting an available date and time when the company vehicle after being returned is available, based on the due date and time and the preparation time.

Another aspect of the present disclosure can be also regarded as an information processing method for managing company vehicles to be lent to employees.

In this case, the information processing method may cause a computer to perform steps of:

acquiring information on the usage state and the due date and time of the company vehicle having been lent;

calculating a preparation time from the due date and time to, a state in which the company vehicle is available, based on the information on the usage state of the company vehicle; and

setting an available date and time when the company vehicle after being returned is available, based on the due date and time and the preparation time.

Another aspect of the present disclosure can be also regarded as a non-temporary storage medium for storing an information processing program for implementing the information processing method.

According to the present disclosure, a technique of efficiently managing the reservation of company vehicles can be provided.

### BRIEF DESCRIPTION OF THE DRAWINGS

FIG. 1 is a schematic diagram illustrating a company-vehicle management system according the present disclosure;

FIG. 2 is a schematic diagram illustrating an example of components provided for the company-vehicle management system according to the present embodiment;

FIG. 3 illustrates an example of a function module included in the controller of a key unit;

FIG. 4 illustrates the table configuration of company vehicle information stored in a lending/borrowing management DB according to the embodiment;

FIG. 5 is a flowchart indicating a processing flow performed by a lending/borrowing management server according to the embodiment;

FIG. 6 illustrates the table configuration-of the company vehicle information stored in the lending/borrowing management DB according to a modification; and

FIG. 7 is a flowchart indicating a processing flow performed by the lending/borrowing management server when a charging time is calculated in the modification.

### DESCRIPTION OF THE EMBODIMENTS

Some company organizations are equipped with vehicles (company vehicles) to be lent to employees. Such lending of company vehicles is implemented by reserving the lending of company vehicles by employees. For example, an employee reserves an available company vehicle for a business trip or the like by matching the available dates and times of company vehicles with the business trip schedule of the employee. At this point, an incorrect setting of the available dates and times of company vehicles may interfere with the work of the employee who has reserved the company vehicle.

In contrast, according to the information processor of the present disclosure, a controller acquires information on the usage state and the due date and time of a lent company vehicle when the available dates and times of company vehicles are set. Subsequently, the controller calculates a preparation time from the due date and time to a state in which the company vehicle is available, based on the information on the usage state of the company vehicle. Based on the due date and the preparation time, the controller then sets a date and time when the company vehicle is available (an available date and time) after being returned. According to the information processor of the present disclosure, an available date and time can be more accurately set in consideration of a preparation time. Consequently, the reservation of company vehicles can be efficiently managed.

In this case, the information on the usage state of a lent company vehicle may include information on the current position of the company vehicle and the current storage amount (first remaining battery power) of a battery for driving the motor of the company vehicle. In this case, based on the current position of the lent company vehicle and the first remaining battery power, the controller may calculate a predicted value (second remaining battery power) of the storage amount of the battery when the company vehicle is returned. Thereafter, the controller may calculate a preparation time according to the second remaining battery power. For example, the controller may set a shorter preparation time as the second remaining battery power increases. This can set an available date and time in consideration of a time for charging the battery.

The controller of the present disclosure may acquire information on a scheduled travel distance of a subsequent user of a lent company vehicle (a user scheduled to borrow the company vehicle (a reserving user) after the company vehicle is returned). Furthermore, the controller may calculate a predicted storage amount of the battery necessary for driving the company vehicle for the scheduled travel distance (battery required amount). Moreover, the controller may calculate a preparation time based on the second remaining battery power and the battery required amount. For example, when the second remaining battery power is at least the battery required amount, the controller may set the preparation time at a predetermined minimum value. The predetermined minimum value is, for example, a time for the maintenance/inspection of the company vehicle without charging the battery. When the second remaining battery power is smaller than the battery required amount, the controller may calculate a preparation time such that the preparation time increases with an increase in a difference between the second remaining battery power and the battery required amount. This is because a time for charging the battery (for example, charging the battery to a storage amount not smaller than the battery required amount) increases with an increase in a difference between the second remaining battery power and the battery required amount. This can set an available date and time suitable for the scheduled travel distance of a reserving user.

As the preparation time increases, an available date and time may be delayed from the start date and time of lending by a reserving user. In this case, the controller may transmit proposal information to the terminal of the reserving user. The proposal information is information for proposing a transporter as an alternative to the company vehicle. This allows the reserving user to conduct work by using the alternative transporter. When a time lag between an available date and time and the start date and time of lending does not interfere with the work of the reserving user, the user may use the company vehicle.

In this case, a main factor of an extension of the preparation time is, for example, an extension of the time for charging the battery and a time lag between an actual return date and time and a due date and time. Thus, the controller may predict an actual return date and time as an actual due date and time of the company vehicle based on the current position of the lent company vehicle. When the predicted actual return date and time is delayed from the due date and time, the controller may calculate a preparation time based on the delay of the actual return date and time from the due date and time in addition to the second remaining battery power. Thus, even if an actual return date and time is delayed from a due date and time, an available date and time can be more accurately set. This can more accurately determine whether the available date and time is delayed from the start date and time of lending by a reserving user.

When a standby company vehicle is available for a reserving user in addition to the lent company vehicle, the controller may add information on the availability of the standby vehicle to the proposal information. In other words, the controller may propose the use of the company vehicle different from the lent company vehicle as an alternative transporter fora reserving user. When such a standby vehicle is not available, the controller may transmit, as the proposal information, information for recommending the use of a rental car to the terminal of a reserving user.

### Embodiment

A specific embodiment of the present disclosure will be described below in accordance with the accompanying drawings. The technical scope of the disclosure is not limited to the dimensions, materials, shapes, and relative arrangements of components in the present embodiment unless otherwise specified.

The present embodiment describes an example in which an information processor according to the present disclosure is applied to a system for managing reservations for lending company vehicles (hereinafter, may be referred to as “company-vehicle management system”).

### Company-vehicle Management System

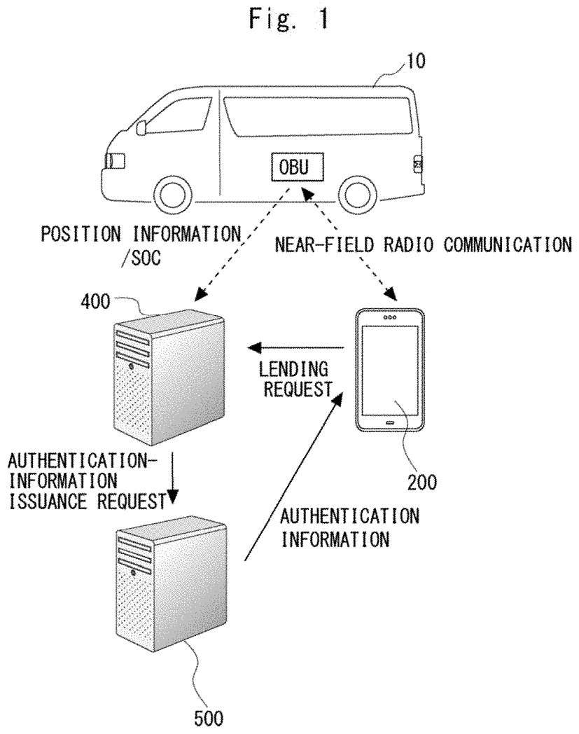

FIG. 1 is a schematic diagram illustrating the company-vehicle management system according to the present embodiment. As illustrated in FIG. 1, the company-vehicle management system according to the present embodiment includes an on-board unit OBU, a user terminal 200, a lending/borrowing management server 400, and a center server 500.

The on-board unit OBU is installed in a company vehicle 10. A company vehicle 10 in the present example is an electric vehicle (EV) driven by an electric motor. The electric motor operates using the output of a battery (driving battery) installed in the company vehicle 10. The on-board unit OBU performs authentication based on terminal authentication information for the user terminal 200. Based on the result of authentication, the on-board unit OBU determines whether to accept vehicle operations (e.g., the operations of locking/unlocking a vehicle door, powering on/off the vehicle, and starting/stopping the motor in the company vehicle 10) through the user terminal 200. The on-board unit OBU also includes the function of acquiring the position of the company vehicle 10 and the storage amount of the driving battery (state of charge (SOC)) and transmitting the position and the storage amount to the lending/borrowing management server 400.

The user terminal 200 is a portable terminal used by a user (employee) who lends the company vehicle 10. The user terminal 200 acquires the terminal authentication information when the user uses the company vehicle 10. When the company vehicle 10 is operated by using the user terminal 200, the user terminal 200 transmits the terminal authentication information to the on-board unit OBU.

The lending/borrowing management server 400 is disposed in, for example, a company owning the company vehicle 10. The lending/borrowing management server 400 manages the reservation of company vehicles. When receiving a lending request signal for the company vehicle 10 from the user terminal 200, the lending/borrowing management server 400 reserves the company vehicle 10 available during a lending period requested by a user. At or immediately before the start of the lending period of the reservation (a start date and time of lending), the lending/borrowing management server 400 requests the center server 500 to transmit the terminal authentication information to the user terminal 200.

Moreover, the lending/borrowing management server 400 sets a date and time when the lent company vehicle 10 is available (an available date and time) after being returned. In the present example, an available date and time is set based on the due date and time and the preparation time of the company vehicle 10. The due date and time is set when a user of the company vehicle 10 (a user using the company vehicle 10) reserves the company vehicle 10. The preparation time is set based on the delay of the predicted value of an actual return date and time from the due date and time and a time for making the returned company vehicle 10 available for lending. The time for making the returned company vehicle 10 available for lending includes a time for the inspection/maintenance of the company vehicle 10 and a time for charging the battery.

The center server 500 is placed in, for example, the dealer of the company vehicle 10, the manufacturer of the company vehicle 10, or an affiliated company thereof. The center server 500 transmits the terminal authentication information to the user terminal 200 based on a request from the lending/borrowing management server 400. When the terminal authentication information transmitted from the center server 500 is received by the user terminal 200, a user to borrow the company vehicle 10 is allowed to operate the company vehicle 10 through the user terminal 200. The terminal authentication information may be directly transmitted from the center server 500 to the user terminal 200 or may be transmitted to the user terminal 200 from the center server 500 through the lending/borrowing management server 400.

### System Configuration

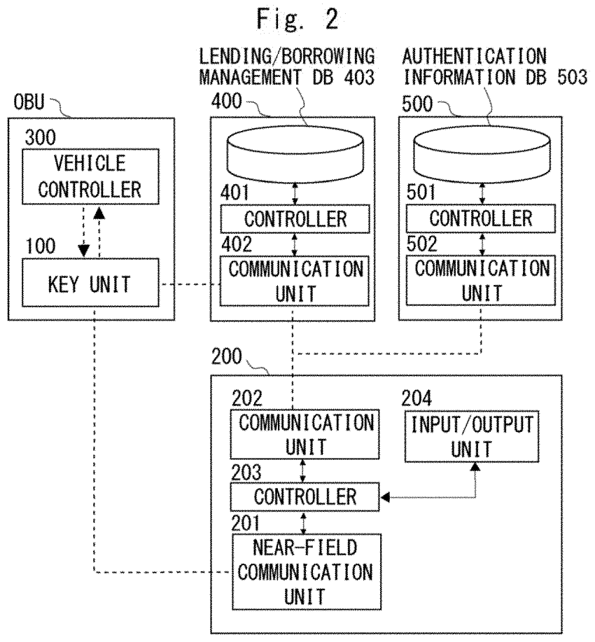

The components of the company-vehicle management system will be specifically described below. FIG. 2 is a block diagram schematically illustrating a configuration example of the on-board unit OBU, the user terminal 200, the lending/borrowing management server 400, and the center server 500 that are illustrated in FIG. 1.

### On-Board Unit OBU

As illustrated in FIG. 2, the on-board unit, OBU includes a key unit 100 and a vehicle controller 300. The key unit 100 includes the same wireless interface as an electronic key (mobile device) of a smart key. With this configuration, the key unit 100 communicates with the vehicle controller 300, so that the company vehicle 10 can be locked/unlocked, the vehicle can be powered on/off, and the motor can be started/stopped without using a physical key. Moreover, the key unit 100 performs near-field radio communications with the user terminal 200 so as to authenticate the user terminal 200 and determines whether the key unit 100 acts as an electronic key of the company vehicle 10 based on the result of authentication.

The vehicle controller 300 is a device for controlling the operations of the vehicle (e.g., the operations of locking/unlocking the door of the company vehicle 10, powering on/off the vehicle, and starting/stopping the motor) and an existing device constituting a part of a smart key system. Specifically, the vehicle controller 300 locks or unlocks the door of the company vehicle 10 in response to a locking signal or an unlocking signal that is transmitted by radio frequency (hereinafter, will be referred to as RF) waves from an electronic key (hereinafter, may be referred to as “mobile device”) allocated to the company vehicle 10. When the vehicle is powered on/off or the motor of the vehicle is started/stopped on the mobile device, the vehicle controller 300 authenticates the mobile device by transmitting low frequency (hereinafter, will be referred to as LF) waves for searching for the mobile device. The vehicle controller 300 also includes the function of accepting the operations when the mobile device is successfully authenticated. In the present example, instead of the mobile device, the key unit 100 transmits and receives RF and LF waves to and from the vehicle controller 300, thereby controlling the operations of the company vehicle 10. Hereinafter, a communication receiver for the vehicle controller 300 is limited to the key unit 100 unless otherwise specified.

The key unit 100 is disposed at a predetermined position (for example, in a glove compartment) in the company vehicle 10. The key unit 100 includes the function of authenticating the user terminal 200 through near-field radio communications with the user terminal 200 and the function of transmitting signals by RF waves to the vehicle controller 300 when the user terminal 200 is successfully authenticated. The key unit 100 also includes the function of authenticating the user terminal 200 through near-field radio communications with the user terminal 200 when receiving a key-ID transmission request by LF waves from the vehicle controller 300. Furthermore, the key unit 100 also includes the function of transmitting the key ID of the key unit 100 to the vehicle controller 300 by RF waves. Moreover, the key unit 100 of the present example also includes the function of successively transmitting the current position of the key unit 100 (that is, the current position of the company vehicle 10) and/or the SOC of the driving battery to the lending/borrowing management server 400.

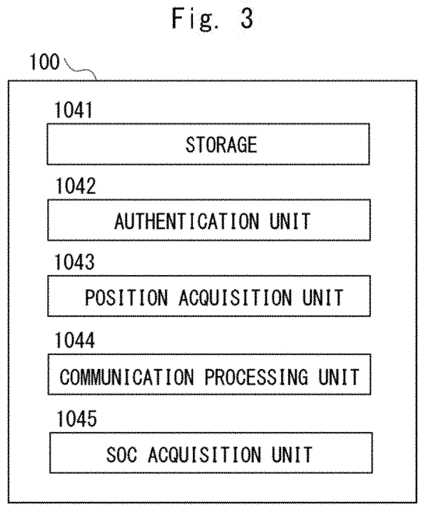

FIG. 3 illustrates a function module included in the key unit 100. As illustrated in FIG. 3, the key unit 100 includes a storage 1041, an authentication unit 1042, a position acquisition unit 1043, a communication processing unit 1044, and an SOC acquisition unit 1045. In the storage 1041, a control program for controlling the key unit 100 is stored. The key unit 100 implements various functions by executing the control program stored in the storage 1041. For example, the key unit 100 implements the function of receiving a polling signal transmitted from the vehicle controller 300 by LF waves and the function of transmitting various signals or a key ID to the vehicle controller 300 by using RF waves. The key unit 100 also implements the function of processing near-field radio communications with the user terminal 200. The key unit 100 also implements the function of generating various signals for vehicle operations or a key ID when the user terminal 200 is successfully authenticated by the authentication unit 1042. The key unit 100 also implements the function of acquiring the current position of the company vehicle 10 and the SOC of the driving battery. The key unit 100 also implements the function of processing radio communications with the lending/borrowing management server 400.

The authentication unit 1042 authenticates the user terminal 200 based on the terminal authentication information received from the user terminal 200. Specifically, the authentication unit 1042 compares authentication information (authentication information specific to the key unit 100) stored in the storage 1041 and the terminal authentication information received from the user terminal 200 and determines that the authentication is successful when the authentication information matches the terminal authentication information. When the authentication information does not match the terminal authentication information, the authentication unit 1042 determines that the authentication has failed.

For example, when the key unit 100 receives a locking request or an unlocking request (hereinafter, will be collectively referred to as “locking/unlocking request”) from the user terminal 200, the authentication unit 1042 first authenticates the user terminal 200 based on the terminal authentication information. When the user terminal 200 is successfully authenticated, the authentication unit 1042 generates a locking/unlocking signal in response to a request received from the user terminal 200. Thereafter, the authentication unit 1042 transmits the generated locking/unlocking signal to the vehicle controller 300 by using RF waves. Hereinafter, the authentication information stored in the storage 1041 of the key unit 100 may be referred to as device authentication information, and the authentication information transmitted from the user terminal 200 may be referred to as terminal authentication information.

When transmitting the locking/unlocking signal to the vehicle controller 300, the authentication unit 1042 also transmits the ID of the electronic key (key ID) to the vehicle controller 300. In this case, the key ID may be stored as plain text in advance in the key unit 100 or may be stored after being encrypted with a cipher specific to the user terminal 200. When the key ID is encrypted before being stored, the authentication unit 1042 may obtain the original key ID by decrypting the encrypted key ID by using the terminal authentication information transmitted from the user terminal 200.

When the key unit 100 receives a key-IR transmission request from the vehicle controller 300, the authentication unit 1042 acquires the terminal authentication information of the user terminal 200 through near-field radio communications with the user terminal 200. The authentication unit 1042 then authenticates the user terminal 200 based on the acquired terminal authentication information. When the user terminal 200 is successfully authenticated, the authentication unit 1042 transmits the key ID of the key unit 100 to the vehicle controller 300 by RF waves.

The position acquisition unit 1043 acquires the current position of the company vehicle 10. Typically, the position acquisition unit 1043 acquires the current position of the company vehicle 10 by using a GPS receiver or the like. The position acquisition unit 1043 of the present example acquires the current position of the company vehicle 10 in a predetermined period. Information on the current position acquired by the position acquisition unit 1043 (position information) is transmitted to the lending/borrowing management server 400 by the communication processing unit 1044, which will be described later. In other words, the position information on the company vehicle 10 is transmitted from the key unit 100 to the lending/borrowing management server 400 in the predetermined period. Thus, the lending/borrowing management server 400 can determine, for example, the current position and the route of the company vehicle 10. The position information on the company vehicle 10 may be transmitted from the key unit 100 to the lending/borrowing management server 400 in response to a request from the lending/borrowing management server 400.

The SOC acquisition unit 1045 acquires the current SOC (hereinafter, may be referred to as “first SOC”) of the driving battery. In this case, the first SOC corresponds to “first remaining battery power” according to the present disclosure. In the acquisition of the first SOC, the SOC acquisition unit 1045 typically acquires the first SOC by using an SOC sensor. The SOC acquisition unit 1045 of the present example acquires the first SOC in the predetermined period. The first SOC acquired by the SOC acquisition unit 1045 is transmitted to the lending/borrowing management server 400 by the communication processing unit 1044, which will be described later. In other words, the first SOC is transmitted from the key unit 100 to the lending/borrowing management server 400 in the predetermined period. Thus, the lending/borrowing management server 400 can determine the first SOC of the company vehicle 10. The first SOC may be transmitted from the key unit 100 to the lending/borrowing management server 400 in response to a request from the lending/borrowing management server 400.

The communication processing unit 1044 transmits, to the lending/borrowing management server 400, the position information acquired by the position acquisition unit 1043 and the first SOC acquired by the SOC acquisition unit 1045. For example, the communication processing unit 1044 transmits the position information and the first SOC to the lending/borrowing management server 400 via a network by using a radio communication circuit. The radio communication circuit is connected to the network by using, for example, mobile communication service of 5G (5th Generation) or LTE (Long Term Evolution). Alternatively, the radio communication circuit may be connected to the network by using, for example, radio communications of Wi-Fi (registered trademark). The position information and the first SOC are transmitted with information (vehicle ID) for identifying the company vehicle 10, from the communication processing unit 1044 to the lending/borrowing management server 400.

### User Terminal 200

The user terminal 200 will be described below. As described above, the user terminal 200 is a terminal carried by a user (employee) who lends the company vehicle 10. The user terminal 200 is a small computer, for example, a smartphone, a cellular phone, a tablet, a personal information terminal, or a wearable computer (e.g., a smart watch). The user terminal 200 thus configured includes a near-field communication unit 201, a communication unit 202, a controller 203, and an input/output unit 204.

The near-field communication unit 201 includes a device for performing near-field radio communications with the key unit 100. For example, the near-field communication unit 201 performs near-field communications (communications inside and outside a vehicle) using a predetermined radio communication standard. The predetermined radio communication standard is, for example, Bluetooth (registered trademark) Low Energy (hereinafter, will be referred to as BLE). The near-field communication unit 201 may perform radio communications with the user terminal 200 by using, for example, NFC (Near Field Communication), UWB (Ultra Wideband), or Wi-Fi (registered trademark).

The communication unit 202 includes a device for connecting the user terminal 2020 to the network. In the present example, the communication unit 202 communicates with other devices via a network by using, for example, mobile communication service of 5G or LTE.

The controller 203 is a computer for controlling the user terminal 200. The controller 203 performs, for example, processing for acquiring the terminal authentication information, processing for generating a locking/unlocking request, and processing for transmitting the terminal authentication information or the locking/unlocking request to the key unit 100. The controller 203 thus configured includes, for example, a microcomputer and implements the function for performing the foregoing processing by executing the program stored in the storage.

The controller 203 interacts with a user via the input/output unit 204. The input/output unit 204 is a device for receiving an input operation by a user and presenting information to the user. Typically, the input/output unit 204 includes a touch panel display.

The controller 203 displays an operation screen on the input/output unit 204 and generates a locking/unlocking request in response to a user operation. For example, the controller 203 outputs a locking icon and/or an unlocking icon to the touch panel display and generates a locking request or an unlocking request based on a user operation. The user operation is not limited to an operation performed via the touch panel display. For example, the user operation may be performed via a hardware switch.

The controller 203 performs processing for acquiring the terminal authentication information. The terminal authentication information is not information (key ID) for authenticating the key unit 100 by the vehicle controller 300 but is information for authenticating the user terminal 200 by the key unit 100 (for example, information associated with device authentication information specific to the key unit 100). Specifically, the controller 203 transmits a signal (lending request signal) for requesting the lending of the company vehicle 10 via the communication unit 202, to the lending/borrowing management server 400. In this case, “lending request signal” includes user identification information for identifying a user who borrows the company vehicle and information on a lending period. The information on the lending period includes, for example, information on a start date and time of lending and an end date and time of lending (due date and time). When the terminal authentication information is transmitted from the center server 500 or the lending/borrowing management server 400 in response to the lending request signal, the controller 203 receives the terminal authentication information through the communication unit 202. The terminal authentication information thus acquired is stored in the storage of the user terminal 200. Hence, the user terminal 200 can operate the company vehicle 10 by using the terminal authentication information stored in the storage.

### Lending/Borrowing Management Server 400

The lending/borrowing management server 400 will be described below. The lending/borrowing management server 400 is a computer that includes a processor, a main storage, and an auxiliary storage and corresponds to an information processor according to the present disclosure. In the auxiliary storage of the lending/borrowing management server 400, an operating system (OS), various programs, and various tables are stored. The processor loads the programs stored in the auxiliary storage into the work area of the main storage, executes the programs, and controls the components through the execution of the programs, thereby implementing functions according to a predetermined purpose. The lending/borrowing management server 400 of the present example includes a controller 401, a communication unit 402, and a lending/borrowing management DB 403 as functional components.

The communication unit 402 connects the lending/borrowing management server 400 to a network. For example, the communication unit 402 communicates with other devices via a network by using a communication network of LAN (Local Area Network), WAN (Wide Area Network), or Wi-Fi (registered trademark). Moreover, the communication unit 402 communicates with the user terminal 200 via a network by using mobile communication service.

The lending/borrowing management DB 403 is formed by storing information on the lent company vehicle 10 in the auxiliary storage. The lending/borrowing management DB 403 thus configured is constructed by managing data stored in the auxiliary storage, the data being managed by the program of a database management system (DBMS), the program being executed by the processor. The lending/borrowing management DB 403 is, for example, a relational database.

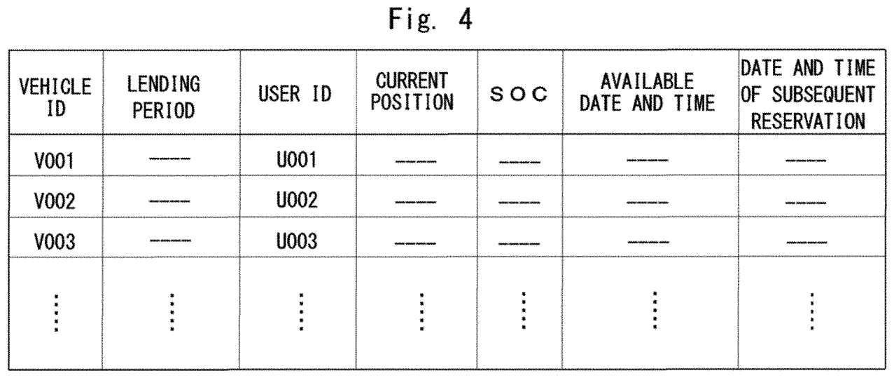

Referring to FIG. 4, a configuration example of information stored in the lending/borrowing management DB 403 will be described below. FIG. 4 indicates the table configuration of information stored in the lending/borrowing management DB 403. As indicated in FIG. 4, a table stored in the lending/borrowing management DB 403 (hereinafter, may be referred to as “company-vehicle information table”) includes the fields of a vehicle ID, a lending period, a user ID, a current position, an SOC, an available date and time, and a date and time of subsequent reservation. In the field of a vehicle ID, the vehicle ID of the lent company vehicle 10 is registered. In the field of a lending period, information on a period during which the company vehicle 10 is lent to a user (lending period) is registered. The information on a lending period includes information on a date and time when the lending of the company vehicle 10 to a user is started (hereinafter, may be referred to as “first start date and time of lending”) and information on a date and time when the user is scheduled to return the company vehicle 10 (due date and time). In the field of a user ID, information for identifying a user of the company vehicle 10 is registered (user ID). In the field of a current position, information on the current position of the lent company vehicle 10 is registered (position information). The information registered in the field of a current position is updated each time the lending/borrowing management server 400 receives position information from the lent company vehicle 10 (on-board unit OBU). In the field of an SOC, information on the current SOC (first SOC) of the driving battery in the lent company vehicle 10 is registered. The information registered in the field of an SOC is information indicating the current storage amount of the driving battery and corresponds to “first battery remaining power” according to the present disclosure. The information registered in the field of an SOC is updated each time the lending/borrowing management server 400 receives an SOC from the lent company vehicle 10 (on-board unit OBU). In the field of an available date and time, information on a date and time when the company vehicle 10 is available after the return of the lent company vehicle 10 is registered (available date and time). The information registered in the field of an available date and time is optionally updated by the controller 401, which will be described later. In the field of a date and time of subsequent reservation, information on a start date, and time of lending for the subsequent reservation of the lent company vehicle 10 is registered (hereinafter, may be referred to as “second start date and time of lending”). In other words, in the field of a date and time of subsequent reservation, a date and time when the lending of the company vehicle 10 to a subsequent user (reserving user) is started is registered. When a subsequent user of the company vehicle 10 is not determined (a subsequent reservation of the company vehicle 10 is not determined), the field of a date and time of subsequent reservation is left blank.

The controller 401 reserves the company vehicle 10 based on a user request. For example, when the communication unit 402 receives the lending request signal from the user terminal 200, the controller 401 extracts information on a lending period from the lending request signal. The controller 401 specifies the company vehicle 10 available in the extracted lending period and reserves the company vehicle 10.

At or immediately before the start of the lending period of the reservation (a start date and time of lending), the controller 401 transmits an authentication-information issuance request signal to the center server 500. The authentication-information issuance request signal is a signal for requesting the transmission of terminal authentication information from the center server 500 to the user terminal 200 so as to enable an operation on the company vehicle 10. The authentication-information issuance request signal includes the vehicle ID of the company vehicle 10 to be lent.

The controller 401 also includes the function of setting an available date and time of the lent company vehicle 10. Specifically, the controller 401 sets an available date and time based on a due date and time and a preparation time. The due date and time is a date and time that is set when a user reserves the company vehicle 10. The preparation time is a required time from the due date and time to a state in which the company vehicle 10 is available. The preparation time of the present example is set based on the delay of an actual return date and time from the due date, a time for charging the driving battery, and a time for the inspection/maintenance of the company vehicle 10.

The delay of the actual return date and time from the due date (hereinafter, may be referred to as “return delay time”) is calculated based on the current position of the lent company vehicle 10. Specifically, the controller 401 first calculates a predicted time (time required) for driving from the current position of the lent company vehicle 10 to a location of return (e.g., a company parking lot). At this point, the controller 401 calculates the required time based on the distance of a route from the current position to the location of return and road traffic information on the route. The required time thus calculated increases with increases in the distance of the route and the degree of congestion of the route. Subsequently, the controller 401 calculates an actual return date and time by adding the required time to the current time. The controller 401 then calculates a return delay time by subtracting the due date and time from the actual return date and time. When the actual return date and time precedes the due date and time, the calculation result includes a negative value, but the return delay time is regarded as “0”.

The time for charging the driving battery (hereinafter, may be referred to as “charging time”) is calculated based on the current position of the lent company vehicle 10 and the first SOC. Specifically, based on the distance of the route from the current position of the lent company vehicle 10 to the location of return, the controller 401 first calculates the predicted consumption of the storage amount of the driving battery (battery power consumption) during the driving of the company vehicle 10 on the route. The controller 401 then subtracts the battery power consumption from the first SOC so as to calculate the predicted value of the SOC (hereinafter, may be referred to as “second SOC”) of the driving battery at the time of return of the company vehicle 10 to the location of return. In this case, the second SOC corresponds to “second remaining battery power” according to the present disclosure. The controller 401 calculates, as a charging time, a time for fully charging the driving battery from the second SOC. The charging time thus calculated increases with a reduction in the second SOC.

The time for the inspection/maintenance of the company vehicle 10 (hereinafter, may be referred to as “inspection/maintenance time”) is a predetermined time. The inspection/maintenance time may be set based on, for example, track records in the past or the results of experiments or simulations.

When the return delay time, the charging time, and the inspection/maintenance time are determined, the controller 401 calculates a preparation time by adding up the times. When the charging of the driving battery and the inspection/maintenance of the company vehicle 10 can be performed in parallel, the controller 401 may calculate the preparation time by adding longer one of the charging time and the inspection/maintenance time to the return delay time.

When the preparation time is determined by the foregoing steps, the controller 401 sets an available date and time by adding the preparation time to the due date and time. The set available date and time is registered in the field of an available date and time in the company-vehicle information table. The processing for setting an available date and time is repeatedly performed each time position information and the SOC are received from the on-board unit OBU of the lent company vehicle 10. Accordingly, information registered in the field of an available date and time in the company-vehicle information table is updated.

Each time information registered in the field of an available date and time is updated, the controller 401 matches the available date and time with a second start date and time of lending in the field of a date and time of subsequent reservation, thereby determining whether the available date and time is delayed from the second start date and time of lending. The processing of determination is performed when the second start date and time of lending is registered in the field of a date and time of subsequent reservation. The processing of determination is not performed when the field of a date and time of subsequent reservation is left blank. When the controller 401 determines that the available date and time is delayed from the second start date and time of lending, the controller 401 transmits proposal information to the user terminal of a reserving user. The proposal information includes information indicating that the available date and time is delayed from the second start date and time of lending, information on a proposal of a transporter as an alternative to the company vehicle 10, and information for prompting the selection of a request for lending the company vehicle 10 or a request for driving with an alternative transporter. The alternative transporter may be, for example, an alternative vehicle that is a company vehicle different from the company vehicle 10 and available in the lending period of a reserving user. When such an alternative vehicle is not available, a rental car available in the lending period of a reserving user may be proposed as an alternative transporter.

When information on a request for driving with an alternative transporter is sent back from the user terminal of the reserving user in response to the proposal information, the controller 401 cancels the reservation of the company vehicle 10. At this point, when the alternative transporter is an alternative vehicle or a rental car, the controller 401 reserves the alternative vehicle or the rental car. When information on a request to lend the company vehicle 10 is sent back from the user terminal of the reserving user in response to the proposal information, the controller 401 does not cancel the reservation of the company vehicle 10. This continues the reservation of the company vehicle 10 by the reserving user. Thus, the reserving user can use the company vehicle 10 from the available date and time.

Any one of the functional components of the lending/borrowing management server 400 or part of the processing thereof may be implemented by another computer connected to the lending/borrowing management server 400 via a network. Although a series of processing performed by the lending/borrowing management server 400 can be implemented by hardware, the series of processing can be also implemented by software.

### Center Server 500

The center server 500 will be described below. The center server 500 is configured like an ordinary computer and includes a basic hardware configuration identical to that of the lending/borrowing management server 400. Thus, in the center server 500, a processor loads the programs stored in the auxiliary storage into the work area of the main storage, executes the programs, and controls the components through the execution of the programs, thereby implementing functions according to a predetermined, purpose. The center server 500 of the present example includes a controller 501, a communication unit 502, and an authentication information DB 503 as functional components.

The communication unit 502 is functionally identical to the communication unit 402 of the lending/borrowing management server 400 and performs communications between the center server 500 and other devices (for example, the lending/borrowing management server 400 or the user terminal 200).

The authentication information DB 503 is formed by storing authentication information in an auxiliary storage. In the authentication information DB 503, the vehicle ID of the company vehicle 10, the device authentication information specific to the key unit 100 installed in the company vehicle 10, and the terminal authentication information associated with the device authentication information are linked to one another. The authentication information DB 503 thus configured is constructed by managing data stored in the auxiliary storage, the data being managed by the program of a DBMS, the program being executed by the processor. The authentication information DB 503 is, for example, a relational database.

The controller 501 performs processing relevant to the issuance of authentication information to the user terminal 200 or the like. Specifically, the controller 501 accesses the authentication information DB 503 in response to the reception of the authentication-information issuance request signal from the lending/borrowing management server 400 by the communication unit 502. The controller 501 then derives, from the authentication information DB 503, the terminal authentication information corresponding to the vehicle ID included in the authentication-information issuance request signal. Subsequently, the controller 501 transmits the terminal authentication information derived from the authentication information DB 503, to the user terminal 200 via the communication unit 502. At this point, the terminal authentication information may be directly transmitted from the center server 500 to the user terminal 200 or may be indirectly transmitted from the center server 500 to the user terminal 200 via the lending/borrowing management server 400.

Any one of the functional components of the center server 500 or part of the processing thereof may be implemented by another computer connected to the center server 500 via a network. Although a series of processing performed by the center server 500 can be implemented by hardware, the series of processing can be also implemented by software.

### Processing Flow

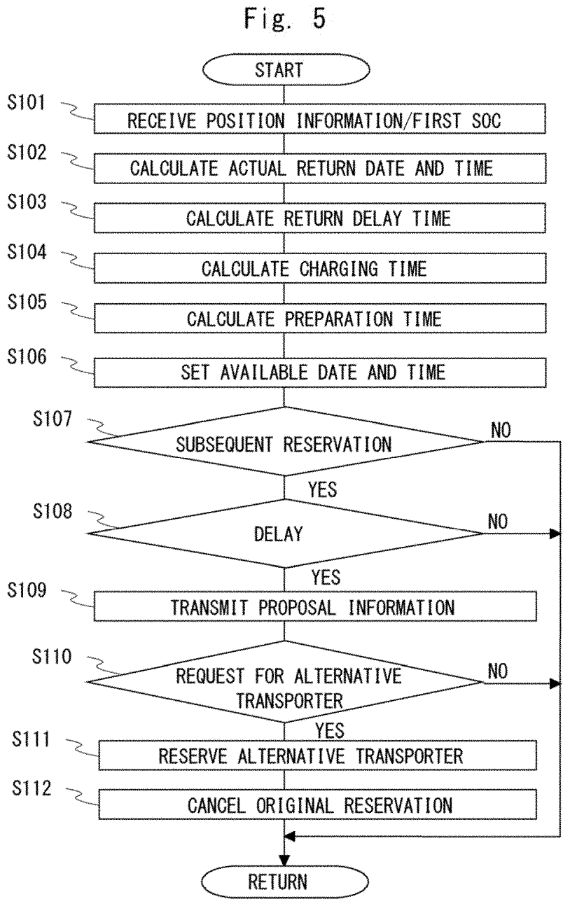

Referring to FIG. 5, a processing flow performed by the lending/borrowing management server 400 will be described below. FIG. 5 is a flowchart indicating the processing flow performed by the lending/borrowing management server 400 when the lending/borrowing management server 400 receives the position information and the first SOC that are transmitted from the on-board unit OBU of the lent company vehicle 10.

In FIG. 5, first, the communication unit 402 of the lending/borrowing management server 400 receives the position information, the first SOC, and the vehicle ID that are transmitted from the lent company vehicle 10 (on-board unit OBU) (step S101). The position information, the first SOC, and the vehicle ID that are received by the communication unit 402 are delivered from the communication unit 402 to the controller 401. The controller 401 accesses the lending/borrowing management DB 403 with the vehicle ID serving as an argument, thereby specifying the company-vehicle information table corresponding to the company vehicle 10. According to the position information and the first SOC that are received in step 5101, the controller 401 updates information registered in the field of a current position and the field of an SOC in the specified company-vehicle information table.

The controller 401 calculates the actual return date and time of the company vehicle 10 (step S102). Specifically, the controller 401 calculates a required time based on the distance of a route from the current position of the company vehicle 10 to the location of return and road traffic information on the route. As described above, the required time is a time for driving from the current position of the company vehicle 10 to the location of return. The controller 401 calculates an actual return date and time by adding the calculated required time to the current time.

The controller 401 calculates the return delay time of the company vehicle 10 (step S103). Specifically, the controller 401 calculates the return delay time by subtracting the due date and time of the company vehicle 10 from the actual return date and time determined in step S102. At this point, when a time obtained by subtracting the due date and time from the actual return date and time includes a negative value, the return delay time is set at “0.”

The controller 401 calculates a time for charging the driving battery (charging time) after the return of the company vehicle 10 (step S104). Specifically, based on the distance of the route from the current position of the company vehicle 10 to the location of return, the controller 401 calculates the predicted consumption of the storage amount of the driving battery (battery power consumption) during the driving of the company vehicle 10 on the route. The controller 401 subtracts the battery power consumption from the first SOC received in step S101, thereby calculating the predicted value of the SOC (second SOC) of the driving battery at the time of return of the company vehicle 10 to the location of return. The controller 401 calculates a time for fully charging the driving battery from the second SOC (charging time).

The controller 401 calculates the preparation time (step S105). Specifically, the controller 401 calculates the preparation time by adding up the return delay time calculated in step S103, the charging time calculated in step S104, and the inspection/maintenance time. As described above, the inspection/maintenance time is a time for the inspection/maintenance of the company vehicle 10 and is set as a predetermined time.

The controller 401 sets a date and time when the company vehicle 10 is available (an available date and time) after being returned (step S106). Specifically, the controller 401 first accesses the company-vehicle information table corresponding to the company vehicle 10 and extracts a due date and time from information registered in the field of a lending period. The controller 401 then sets an available date and time by adding the preparation time calculated in step S105 to the due date and time. The available date and time thus set is registered in the field of an available date and time in the company-vehicle information table corresponding to the company vehicle 10. At this point, when a previous value has been registered in the field of an available date and time, the controller 401 updates the information in the field of an available date and time according to the available date and time set in step S106.

The controller 401 determines the presence or. absence of a subsequent reservation of the company vehicle 10 (step S107). At this point, when the second start date and time of lending has been registered in the field of a date and time of subsequent reservation in the company-vehicle information table corresponding to the company vehicle 10, the presence of a subsequent reservation of the company vehicle 10 is determined (yes in step S107). When the field of a date and time of subsequent reservation is left blank in the company-vehicle information table corresponding to the company vehicle 10, the absence of a subsequent reservation of the company vehicle 10 is determined (no in step S107).

In the case of no in step S107, the execution of the processing flow of FIG. 5 is terminated. In this case, the available date and time of the company vehicle 10 is used for determining the availability of the company vehicle 10 (whether the company vehicle 10 can be reserved or not) in a subsequent reservation. For example, when a lending request signal is received from a user terminal, the start date and time of a lending period included in the lending request signal (first start date and time of lending) is checked against the available date and time, thereby determining whether the company vehicle 10 is available for reservation in response to the lending request signal. Thus, the availability of the company vehicle 10 can be more accurately determined.

In the case of yes in step S107, the controller 401 predicts whether the, return of the company vehicle 10 is delayed or not (step S108). Specifically, the controller 401 determines whether the available date and time set in step S106 is delayed from the due date and time of the company vehicle 10. At this point, when the available date and time precedes the due date and time (no in step S108), the execution of the processing flow of FIG. 5 is terminated. When the available date and time is delayed from the due date and time (yes in step S108), the processing of step S109 is performed.

In step S109, the controller 401 transmits proposal information to the user terminal of a subsequent user (a reserving user) of the company vehicle 10. As described above, the proposed information includes three items of information as follows:

(Information 1) Information indicating that the available date and time of the company vehicle 10 is delayed from the second start date and time of lending

(Information 2) Information on a proposal of a transporter as an alternative to the company vehicle 10

(Information 3) Information for prompting the selection of a request for lending the company vehicle 10 or a request for driving with an alternative transporter.

The alternative transporter in the present example is a company vehicle that is different from the company vehicle 10 and is available in the lending period of a reserving user or a rental car available in the lending period of a reserving user.

When the communication unit 402 receives, from the user terminal, a response signal for the proposal information transmitted from the lending/borrowing management server 400 in step S109, the controller 401 determines whether the response signal indicates a request for an alternative transporter (step S110). When the response signal indicates a request for lending the company vehicle 10 (no in step S110), the execution of the processing flow of FIG. 5 is terminated. In this case, the reservation of the company vehicle 10 by a reserving user is continued. Thus, the reserving user can use the company vehicle 10 from the available date and time. When the response signal indicates a request for driving with an alternative transporter (yes in step S110), the controller 401 performs the processing of step S111.

In step S111, the controller 401 performs processing for reserving an alternative transporter. The controller 401 then cancels the reservation (original reservation) of the company vehicle 10 by the reserving user (step S112). This allows the reserving user to use an alternative transporter from the second start date and time of lending. Thus, when the return of the company vehicle 10 reserved by the reserving user is delayed from the due date and time, the reserving user can conduct work by using the alternative transporter.

According to the processing flow of FIG. 5, the available date and time of the lent company vehicle 10 can be more accurately set. Hence, the company vehicle 10 can be accurately and efficiently reserved. This can suppress interference with the work of a user (employee) having reserved the company vehicle 10.

### Modification

In the example of the foregoing embodiment, a time for fully charging the driving battery from the second SOC is calculated as a charging time. In contrast, in the present modification, a charging time is calculated according to the battery required amount of a reserving user when the subsequent reservation of the lent company vehicle 10 is determined. In this case, “battery required amount” is a predicted necessary storage amount of the driving battery when the reserving user is scheduled to drive the company vehicle 10 for a scheduled distance (scheduled travel distance).

When a user, that is, an employee reserves the company vehicle 10, a destination (the destination of a business trip) may be reported. In this case, a scheduled travel distance for a round trip between a company (the location of lending and return of the company vehicle 10) and a destination using the company vehicle 10 can be determined in advance. Accordingly, a battery required amount for driving the company vehicle 10 for the scheduled travel distance can be determined. When the SOC of the driving battery reaches at least the battery required amount when the company vehicle 10 is lent to the reserving user, the travel of the reserving user by the company vehicle 10 can be ensured.

Thus, when the subsequent reservation of the lent company vehicle 10 is determined in the present modification, a time for charging the driving battery from the second SOC to the battery required amount is calculated as a charging time. When the subsequent reservation of the lent company vehicle 10 is not determined, a time for fully charging the driving battery from the second SOC is calculated as a charging time as in the foregoing embodiment.

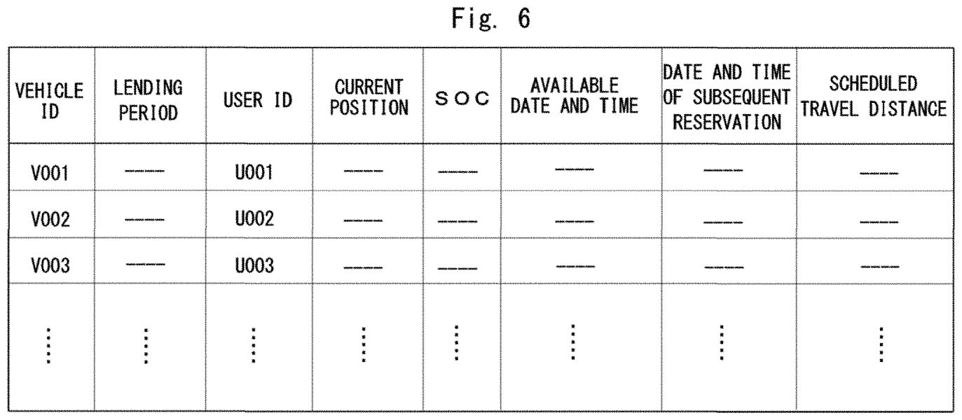

FIG. 6 indicates a configuration example of the company-vehicle information table according to the present modification. As indicated in FIG. 6, the company-vehicle information table in the present modification includes the field of a scheduled travel distance in addition to the fields of a vehicle ID, a lending period, a user ID, a current position, an SOC, an available date and time, and a date and time of subsequent reservation. In the field of a scheduled travel distance, information on a scheduled distance of travel by a reserving user with the company vehicle 10 is registered. As described above, the scheduled travel distance registered in the field of the scheduled travel distance is a travel distance for a round trip on a route connecting a company and the destination of a business trip by the reserving user. When the subsequent reservation of the lent company vehicle 10 is not determined, the field of a date and time of subsequent reservation and the field of a scheduled travel distance are left blank.

### Processing Flow

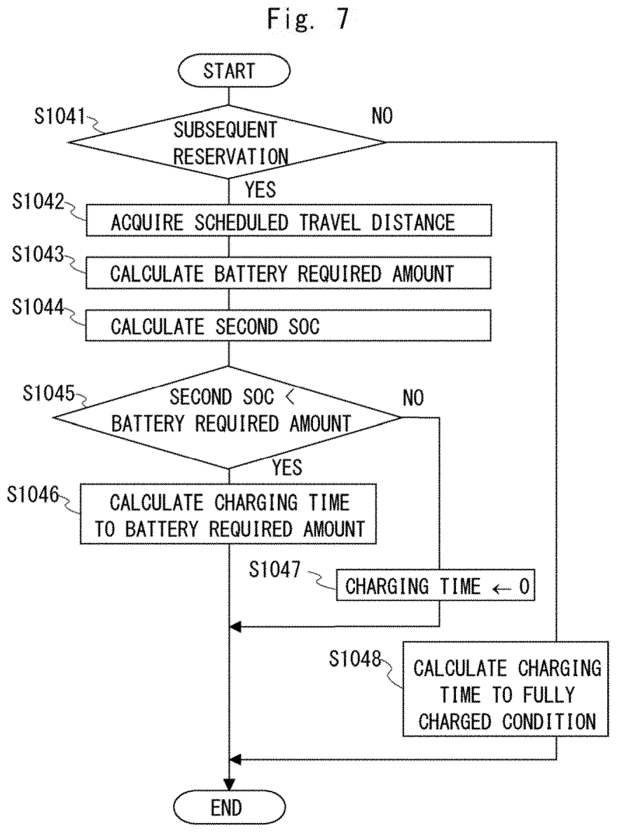

Referring to FIG. 7, steps of calculating a charging time according to the present modification will be described below. FIG. 7 is a flowchart indicating a processing flow performed instead of step S104 in FIG. 5.

In FIG. 7, the controller 401 of the lending/borrowing management server 400 determines whether a scheduled travel distance is registered in the field of a scheduled travel distance in the company-vehicle information table. In other words, the controller 401 determines whether a subsequent reservation of the lent company vehicle 10 is determined (step S1041). At this point, when the field of a scheduled travel distance in the company-vehicle information table is left blank, it is determined that a subsequent reservation of the company vehicle 10 is not determined (no in step S1041). When a scheduled travel distance is registered in the field of a scheduled travel distance in the company-vehicle information table, it is determined that a subsequent reservation of the company vehicle 10 is determined (yes in step S1041). As another method of determining whether a subsequent reservation of the lent company vehicle 10 is determined, the controller 401 may determine whether a second start date and time of reservation is registered in the field of a date and time of subsequent reservation in the company-vehicle information table.

In the case of no in step S1041, the controller 401 calculates a charging time in the same steps as those of the foregoing embodiment. Specifically, the controller 401 calculates, as a charging time, a time for fully charging the driving battery from the second SOC (step S1048).

In the case of yes in step S1041, the controller 401 acquires the scheduled travel distance of a scheduled user (step S1042). Specifically, the controller 401 extracts information (scheduled travel distance) registered in the field of a scheduled travel distance in the company-vehicle information table.

The controller 401 calculates a battery required amount (step S1043). Specifically, the controller 401 calculates a battery required amount based on the scheduled travel distance acquired in step S1042. At this point, the longer the scheduled travel distance, the larger the calculated battery required amount.

The controller 401 calculates the second SOC in the same steps as those of the foregoing embodiment (step S1044). The controller 401 then determines whether the second SOC calculated in step S1044 is smaller than the battery required amount calculated in step S1043 (step S1045).

When the second SOC is smaller than the battery required amount (yes in step S1045), the controller 401 calculates, as a charging time, a time for charging the driving battery from the second SOC to the battery required amount (step S1046). At this point, the larger the difference between the second SOC and the battery required amount, the longer the calculated charging time. In this case, a preparation time is calculated based on a return delay time, the charging time, and an inspection/maintenance time. The preparation time thus calculated is reduced to a minimum length.

When the second SOC is at least the battery required amount (no in step S1045), the controller 401 sets the charging time at “0” (step S1047). In this case, the preparation time is calculated based on the return delay time and the inspection/maintenance time. The preparation time thus calculated is reduced to a minimum value without the need for charging the driving battery.

The processing flow of FIG. 7 can minimize the charging time, thereby minimizing the preparation time accordingly. This can maximize the operating rate of the company vehicle 10.

### Others

The foregoing embodiment and modification are merely exemplary, and the present disclosure can be optionally changed without departing from the scope of the present disclosure. For example, the processing in the lending/borrowing management server 400 and the processing in the center server 500 may be performed in a single server. Specifically, the processing for reservation, the processing for acquiring the terminal authentication information, the processing for setting an available date and time, the processing for issuing the terminal authentication information, and the processing for reserving an alternative transporter may be performed in a single server.

Moreover, the processing and unit described in the present disclosure may be optionally implemented in combination unless a technical contradiction arises. Furthermore, the processing assumed to be performed by a single device may be shared among multiple devices. Alternatively, the processing assumed to be performed by different devices may be performed by a single device. In a computer system, the hardware configuration of functions can be flexibly changed.

The present disclosure can be also implemented by providing a computer with a computer program including the functions of the foregoing embodiment and reading and executing the program read by at least one processor included in the computer. Such a computer program may be provided for the computer by a non-temporary computer-readable storage medium that is connectable to the system bus of the computer or may be provided for the computer via a network. The non-temporary computer-readable storage medium is a recording medium in which information including data and programs can be stored by an electrical, magnetic, optical, mechanical, or chemical action and can be read from a computer or the like. Such recording media may be any types of disks including, for example, a magnetic disk (a floppy (registered trademark) disk or a hard disk drive (HDD)) and an optical disc (a CD-ROM or a DVD disc/Blu-ray Disc). Alternatively, such a recording medium may be read-only memory (ROM), random access memory (RAM), EPROM, EEPROM, a magnetic card, a flash memory, an optical card, or an SSD (Solid State Drive).

What is claimed is:

1. An information processor for managing a company vehicle to be lent to an employee,
the information processor comprising a controller including at least one processor configured to perform:
acquiring information on a usage state and a due date and time of the company vehicle having been lent;
calculating a preparation time from the due date and time to a state in which the company vehicle is available, based on the information on the usage state of the company vehicle; and
setting an available date and time when the company vehicle after being returned is available, based on the due date and time and the preparation time.

2. The information processor according to claim 1, wherein the usage state of the company vehicle includes information on a current position of the company vehicle and first remaining battery power as a current storage amount of a battery for driving a motor of the company vehicle, and
the controller calculates second remaining battery power as a predicted value of the storage amount of the battery at a time of return of the company vehicle based on the current position of the company vehicle and the first remaining battery power and calculates the preparation time based on the second remaining battery power.

3. The information processor according to claim 2, wherein the controller further predicts an actual return date and time as an actual due date and time of the company vehicle based on the current position of the company vehicle, and
when the actual return date and time is delayed from the due date and time, the controller calculates the preparation time based on a delay of the actual return date and time from the due date and time in addition to the second remaining battery power.

4. The information processor according to claim 2, wherein the controller further acquires information on a scheduled travel distance of a reserving user scheduled to borrow the company vehicle after the company vehicle is returned, and
calculates a battery required amount as a predicted storage amount of the battery necessary for driving the company vehicle for the scheduled travel distance, and
the controller calculates the preparation time based on the battery required amount in addition to the second remaining battery power.

5. The information processor according to claim 4, wherein the controller sets the preparation time at a predetermined minimum value when the second remaining battery power is at least the battery required amount, and
the controller calculates the preparation time such that the preparation time increases with an increase in a difference between the second remaining battery power and the battery required amount when the second remaining battery power is smaller than the battery required amount.

6. The information processor according to claim 4, wherein the controller transmits proposal information to a terminal used by the reserving user when the available date and time is delayed from a start date and time of lending of the company vehicle, the start date and time being needed by the reserving user, the proposal information being transmitted as information for proposing a transporter as an alternative to the company vehicle.

7. The information processor according to claim 6, wherein when a standby vehicle different from the company vehicle is available for the reserving user scheduled to borrow the company vehicle after the company vehicle is returned, the controller adds information on availability of the standby vehicle to the proposal information.

8. The information processor according to claim 7, wherein when the standby vehicle is unavailable, the controller adds information for recommending use of a rental car to the proposal information.

9. An information processing method for managing a company vehicle to be lent to an employee, the method causing a computer to perform steps of:
acquiring information on a usage state and a due date and time of the company vehicle having been lent;
calculating a preparation time from the due date and time to a state in which the company vehicle is available, based on the information on the usage state of the company vehicle; and
setting an available date and time when the company vehicle after being returned is available, based on the due date and time and the preparation time.

10. The information processing method according to claim 9, wherein the usage state of the company vehicle includes information on a current position of the company vehicle and first remaining battery power as a current storage amount of a battery for driving a motor of the company vehicle, and in the step of calculating the preparation time, second remaining battery power is calculated as a predicted value of the storage amount of the battery at a time of return of the company vehicle based on the current position of the company vehicle and the first remaining battery power, and the preparation time is calculated based on the second remaining battery power.

11. The information processing method according to claim 10, further comprising a step of predicting an actual return date and time as an actual due date and time of the company vehicle based on the current position of the company vehicle,
wherein in the step of calculating the preparation time, when the actual return date and time is delayed from the due date and time, the preparation time is calculated based on a delay of the actual return date and time from the due date and time in addition to the second remaining battery power.

12. The information processing method according to claim 10, further comprising steps of:
acquiring information on a scheduled travel distance of a reserving user scheduled to borrow the company vehicle after the company vehicle is returned, and
calculating a battery required amount as a predicted battery storage amount for driving the company vehicle for the scheduled travel distance,
wherein in the step of calculating the preparation time, the preparation time is calculated based on the battery required amount in addition to the second remaining battery power.

13. The information processing method according to claim 12, wherein in the step of calculating the preparation time,
the preparation time is set at a predetermined minimum value when the second remaining battery power is at least the battery required amount, and
when the second remaining battery power is smaller than the battery required amount, the preparation time is calculated such that that the preparation time increases with an increase in a difference between the second remaining battery power and the battery required amount.

14. The information processing method according to claim 12, further comprising the step of transmitting proposal information to a terminal used by the reserving user when the available date and time is delayed from a start date and time of lending of the company vehicle, the start date and time being needed by the reserving user, the proposal information being transmitted as information for proposing a transporter as an alternative to the company vehicle.

15. The information processing method according to claim 14, wherein when a standby vehicle different from the company vehicle is available for the reserving user scheduled to borrow the company vehicle after the company vehicle is returned, information on availability of the standby vehicle is added to the proposal information.

16. The information processing method according to claim 15, wherein when the standby vehicle is unavailable, information for recommending use of a rental car is added to the proposal information.

17. A non-temporary storage medium for storing an information processing program for managing a company vehicle to be lent to an employee, the information processing program causing a computer to perform steps of:
acquiring information on a usage state and a due date and time of the company vehicle having been lent
calculating a preparation time from the due date and time to a state in which the company vehicle is available, based on the information on the usage state of the company vehicle; and
setting an available date and time when the company vehicle after being returned is available, based on the due date and time and the preparation time.

18. The non-temporary storage medium for storing an information processing program according to claim 17, wherein the usage state, of the company vehicle includes information on a current position of the company vehicle and first remaining battery power as a current storage amount of a battery for driving a motor of the company vehicle, and
in the step of calculating the preparation time, second remaining battery power is calculated as a predicted value of the storage amount of the battery at a time of return of the company vehicle based on the current position of the company vehicle and the first remaining battery power, and the preparation time is calculated based on the second remaining battery power.

19. The non-temporary storage medium for storing an information processing program according to claim 18, the program further comprising a step of predicting an actual return date and time as an actual due date and time of the company vehicle based on the current position of the company vehicle,
wherein in the step of calculating the preparation time, when the actual return date and time is delayed from the due date and time, the preparation time is calculated based on a delay of the actual return date and time from the due date and time in addition to the second remaining battery power.

20. The non-temporary storage medium for storing an information processing program according to claim 18, the program further comprising steps of:
acquiring information on a scheduled travel distance of a reserving user scheduled to borrow the company vehicle after the company vehicle is returned; and
calculating a battery required amount as a predicted storage amount of the battery required for driving the company vehicle for the scheduled travel distance,
wherein in the step of calculating the preparation time, the preparation time is calculated based on the battery required amount in addition to the second remaining battery power.
